(19) United States
(12) Patent Application Publication
(10) Pub. No.: US 2026/0145981 A1
(43) Pub. Date: May 28, 2026

(54) Method, System, and Computer Program Product for Controlling Glass Production

(71) Applicant: Vitro Flat Glass LLC., Cheswick, PA (US)

(72) Inventors: Wei Xu, Cheswick, PA (US); Alan Dum, Pittsburgh, PA (US); Russell W. Schrier, Oakmont, PA (US); Carl Wilson, Pittsburgh, PA (US)

(21) Appl. No.: 19/365,912

(22) Filed: Oct. 22, 2025

Related U.S. Application Data
(60) Provisional application No. 63/714,661, filed on Oct. 31, 2024.

(51) Int. Cl. C03B 18/06; C03B 18/18

(52) U.S. Cl. CPC C03B 18/06; C03B 18/18

(57) ABSTRACT

A method for controlling glass production includes: pouring a glass melt onto a glass production bath to form a glass ribbon; stretching the glass ribbon on the glass production bath with an edge roll proximate to an edge of the glass ribbon and in contact with an air side surface of the glass ribbon, the edge roll configured to control a width of the glass ribbon; receiving visual data from a camera positioned with a view of the glass ribbon; processing the visual data to determine a value of a dimension associated with the glass ribbon in a region proximate the edge roll; determining that the value of the dimension associated with the glass ribbon and/or an oscillational frequency of the value in the region proximate the edge roll fails to satisfy a threshold value; and generating an alert associated with the edge roll.

### CROSS-REFERENCE TO RELATED APPLICATIONS

This application claims priority to U.S. Provisional Application No. 63/714,661 filed Oct. 31, 2024, the disclosure of which is hereby incorporated by reference in its entirety.

### BACKGROUND

### Field

The present disclosure is directed to a method, system, and computer program product for controlling glass production.

### Technical Considerations

Glass manufacturing may involve melting a glass composition and causing the molten glass to flow onto a bath of molten metal, where the molten glass spreads into a long plane atop the molten metal, so that the molten glass can be manipulated, cooled and transported to later steps in the glass manufacturing. In certain techniques, the glass batch and cullet are melted in a glass melting furnace to form a glass melt, which is released into a bath containing the molten metal via a pouring channel. The glass melt floats on the molten metal to form a glass ribbon. The glass ribbon is stretched by one or more edge roll to alter the shape of the glass ribbon. The edge roll is a mechanical component subject to periodic degradation and/or failure that can impede the ability to properly stretch the glass ribbon.

### SUMMARY OF THE DISCLOSURE

According to some non-limiting aspects of the disclosure, a method for controlling glass production includes: pouring a glass melt onto a glass production bath of molten metal onto which the glass melt floats to form a glass ribbon; stretching the glass ribbon on the glass production bath with at least one edge roll proximate to an edge of the glass ribbon and in contact with an air side surface of the glass ribbon, the at least one edge roll configured to impose an outward force or inward force on the edge of the glass ribbon to control a width of the glass ribbon; receiving, with at least one processor, visual data from at least one camera positioned with a view of the glass ribbon; processing, with at least one processor, the visual data to determine a value of at least one dimension associated with the glass ribbon in a region proximate the at least one edge roll; determining, with at least one processor, that the value of the at least one dimension associated with the glass ribbon and/or an oscillational frequency of the value in the region proximate the at least one edge roll fails to satisfy a threshold value; and generating, with at least one processor, at least one alert associated with the at least one edge roll.

In some non-limiting aspects, the at least one dimension associated with the glass ribbon may include a first width of the glass ribbon in the region proximate the at least one edge roll and/or a distance between the edge of the glass ribbon and the at least one edge roll. The stretching step may include a plurality of edge rolls, and the at least one edge roll may include a subset of the plurality of edge rolls. The method may further include: in response to the at least one alert, maintenancing the at least one edge roll. The method may further include: in response to the at least one alert, transmitting a control signal to the at least one edge roll configured to cause the at least one edge roll to execute a response action. The response action may include an adjustment of at least one of: a rotation speed of the at least one edge roll, a location of the at least one edge roll in the glass ribbon, an angle of the at least one edge roll in the glass ribbon, a depth of the edge roll into the glass ribbon, and/or any combination thereof. The method may further include: in response to the at least one alert, transmitting a control signal to a heating element located in the glass production bath to cause the heating element to execute a response action. Determining the value of at least one dimension associated with the glass ribbon in the region proximate the at least one edge roll may include determining a first width of the molten glass in the region proximate the at least one edge roll and/or a distance between the edge of the glass ribbon and the at least one edge roll by: identifying, with at least one processor, a location of the at least one edge roll in the visual data; starting from the location of the at least one edge roll in the visual data, searching, with at least one processor, for a location of a first edge of the glass ribbon in the visual data by searching around the location of the at least one edge roll in the visual data; identifying, with at least one processor, the location of the first edge of the glass ribbon in the visual data by the searching; and based on the location of the first edge of the glass ribbon in the visual data, determining, with at least one processor, the width of the glass ribbon in the region proximate the at least one edge roll and/or the distance between the edge of the glass ribbon and the at least one edge roll. Determining the value of at least one dimension associated with the glass ribbon in the region proximate the at least one edge roll may include determining a first width of the glass ribbon in the region proximate the at least one edge roll and/or a distance between the edge of the glass ribbon and the at least one edge roll by: receiving, with at least one processor, an input of at least one user-defined search area and/or user-defined characteristic object in the visual data; starting from the location of the at least one user-defined search area and/or user-defined characteristic object in the visual data, searching, with at least one processor, for a location of a first edge of the glass ribbon in the visual data by searching around the at least one user-defined search area and/or user-defined characteristic object in the visual data; identifying, with at least one processor, the location of the first edge of the glass ribbon in the visual data by the searching; and based on the location of the first edge of the glass ribbon in the visual data, determining, with at least one processor, the first width of the glass ribbon in the region proximate the at least one edge roll and/or the distance between the edge of the glass ribbon and the at least one edge roll.

In some non-limiting aspects, the method may further include: determining, with at least one processor, that an image quality of the visual data fails to satisfy a threshold; and in response to determining that the image quality of the visual data fails to satisfy the threshold: (1) generating, with at least one processor, a notification associated with the at least one camera; and/or (2) cease generating control signals based on the visual data until the image quality of the visual data satisfies the threshold. The method may further include: determining, with at least one processor, image quality of the visual data; and based on the determined image quality, automatically adjusting, with at least one processor, an image processing parameter and/or a camera setting associated with the at least one camera. The method may further include: in response to the at least one alert, transmitting, with at least one processor, a control signal to the at least one edge roll and/or a heating element located in the glass production bath; measuring a response to the control signal by measuring a position of the edge of the glass ribbon and/or a distance between the edge of the glass ribbon and the at least one edge roll; comparing, with at least one processor, the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generating, with at least one processor, a further control signal for the at least one edge roll and/or the heating element based on the comparison.

According to some non-limiting aspects of the disclosure, a system for controlling glass production includes: a glass production bath including a bath of molten metal onto which a glass ribbon floats, the glass production bath including at least one edge roll proximate an edge of the glass ribbon, the at least one edge roll configured to impose an outward force or an inward force on the edge of the glass ribbon to control a width of the glass ribbon; and at least one processor configured to: receive visual data from at least one camera positioned with a view of the glass ribbon; process the visual data to determine a value of at least one dimension associated with the glass ribbon in the region proximate the at least one edge roll; determine that the value of the at least one dimension associated with the glass ribbon and/or an oscillational frequency of the value in the region proximate the at least one edge roll fails to satisfy a threshold value; and generate at least one alert associated with the at least one edge roll.

In some non-limiting aspects, the at least one dimension associated with the glass ribbon may include a first width of the glass ribbon in the region proximate the at least one edge roll and/or a distance between the edge of the glass ribbon and the at least one edge roll. The glass production bath may further include a plurality of edge rolls, and the at least one edge roll may include a subset of the plurality of edge rolls. In response to the at least one alert, the at least one edge roll may be maintenanced. The at least one processor may be configured to: in response to the at least one alert, transmit a control signal to the at least one edge roll configured to cause the at least one edge roll to execute a response action. The response action may include an adjustment of at least one of: a rotation speed of the at least one edge roll, a location of the at least one edge roll in the glass ribbon, an angle of the at least one edge roll in the glass ribbon, a depth of the at least one edge roll in an air side surface of the glass ribbon, and/or any combination thereof. The at least one processor may be configured to: in response to the at least one alert, transmit a control signal to a heating element located in the glass production bath to cause the heating element to execute a response action. Determining the value of at least one dimension associated with the glass ribbon in the region proximate the at least one edge roll may include determining a first width of the glass ribbon in the region proximate the at least one edge roll and/or a distance between the edge of the glass ribbon and the at least one edge roll by: identifying a location of the at least one edge roll in the visual data; starting from the location of the at least one edge roll in the visual data, searching for a location of a first edge of the glass ribbon in the visual data by searching around the location of the at least one edge roll in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll. Determining the value of at least one dimension associated with the glass ribbon in the region proximate the at least one edge roll may include determining a first width of the glass ribbon in the region proximate the at least one edge roll and/or a distance between the edge of the glass ribbon and the at least one edge roll by: receiving an input of at least one user-defined search area and/or user-defined characteristic object in the visual data; starting from the location of the at least one user-defined search area and/or user-defined characteristic object in the visual data, searching for a location of a first edge of the glass ribbon in the visual data by searching around the at least one user-defined search area and/or user-defined characteristic object in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll.

In some non-limiting aspects, the at least one processor may be configured to: determine that an image quality of the visual data fails to satisfy a threshold; and in response to determining that the image quality of the visual data fails to satisfy the threshold: (1) generate a notification associated with the at least one camera; and/or (2) cease generating control signals based on the visual data until the image quality of the visual data satisfies the threshold. The at least one processor may be configured to: determine image quality of the visual data; and based on the determined image quality, automatically adjust an image processing parameter and/or a camera setting associated with the at least one camera. The at least one processor may be configured to: in response to the at least one alert, transmit a control signal to the at least one edge roll and/or a heating element located in the glass production bath; measure a response to the control signal by measuring a position of the edge of the glass ribbon and/or a distance between the edge of the glass ribbon and the at least one edge roll; compare the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generate a further control signal for the at least one edge roll and/or the heating element based on the comparison.

According to some non-limiting aspects of the disclosure, a computer program product for controlling glass production includes at least one non-transitory computer-readable medium including one or more instructions that, when executed by at least one processor, cause the at least one processor to: receive visual data from at least one camera positioned with a view of a glass ribbon floating in a glass production bath, the glass production bath including a molten metal onto which the glass ribbon floats, the glass production bath including at least one edge roll positioned proximate an edge of the glass ribbon, the at least one edge roll configured to impose an outward force or an inward force on the edge of the glass ribbon to control a width of the glass ribbon; process the visual data to determine a value of at least one dimension associated with the glass ribbon in a region proximate the at least one edge roll; determine that the value of the at least one dimension associated with the glass ribbon and/or an oscillational frequency of the value in the region proximate the at least one edge roll fails to satisfy a threshold value; and generate at least one alert associated with the at least one edge roll.

In some non-limiting aspects, the at least one dimension associated with the glass ribbon may include a first width of the glass ribbon in the region proximate the at least one edge roll and/or a distance between the edge of the glass ribbon and the at least one edge roll. The glass production bath may include a plurality of edge rolls, and the at least one edge roll may include a subset of the plurality of edge rolls. In response to the at least one alert, the at least one edge roll may be maintenanced. The one or more instructions may cause the at least one processor to: in response to the at least one alert, transmit a control signal to the at least one edge roll configured to cause the at least one edge roll to execute a response action. The response action may include an adjustment of at least one of: a rotation speed of the at least one edge roll, a location of the at least one edge roll in the glass ribbon, an angle of the at least one edge roll in the glass ribbon, a depth of the edge roll in the glass ribbon, and/or any combination thereof. The one or more instructions may cause the at least one processor to: in response to the at least one alert, transmit a control signal to a heating element located in the glass production bath to cause the heating element to execute a response action. Determining the value of at least one dimension associated with the glass ribbon in the region proximate the at least one edge roll may include determining a first width of the glass ribbon in the region proximate the at least one edge roll and/or a distance between the edge of the glass ribbon and the at least one edge roll by: identifying a location of the at least one edge roll in the visual data; starting from the location of the at least one edge roll in the visual data, searching for a location of a first edge of the glass ribbon in the visual data by searching around the location of the at least one edge roll in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll. Determining the value of at least one dimension associated with the glass ribbon in the region proximate the at least one edge roll may include determining a first width of the glass ribbon in the region proximate the at least one edge roll and/or a distance between the edge of the glass ribbon and the at least one edge roll by: receiving an input of at least one user-defined search area and/or user-defined characteristic object in the visual data; starting from the location of the at least one user-defined search area and/or user-defined characteristic object in the visual data, searching for a location of a first edge of the glass ribbon in the visual data by searching around the at least one user-defined search area and/or user-defined characteristic object in the visual data; identifying the location of the first edge of the glass ribbon in the visual data by the searching; and based on the location of the first edge of the glass ribbon in the visual data, determining the width of the molten glass in the region proximate the at least one edge roll and/or the distance between the edge of the glass ribbon and the at least one edge roll.

In some non-limiting aspects, the one or more instructions cause the at least one processor to: determine that an image quality of the visual data fails to satisfy a threshold; and in response to determining that the image quality of the visual data fails to satisfy the threshold: (1) generate a notification associated with the at least one camera; and/or (2) cease generating control signals based on the visual data until the image quality of the visual data satisfies the threshold. The one or more instructions cause the at least one processor to: determine image quality of the visual data; and based on the determined image quality, automatically adjust an image processing parameter and/or a camera setting associated with the at least one camera. The one or more instructions cause the at least one processor to: in response to the at least one alert, transmit a control signal to the at least one edge roll and/or a heating element located in the glass production bath; measure a response to the control signal by measuring a position of the edge of the glass ribbon and/or a distance between the edge of the glass ribbon and the at least one edge roll; compare the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generate a further control signal for the at least one edge roll and/or the heating element based on the comparison.

The following numbered clauses are illustrative of various aspects of the disclosure:

Clause 1: A method for controlling glass production, comprising: pouring a glass melt onto a glass production bath of molten metal onto which the glass melt floats to form a glass ribbon; stretching the glass ribbon on the glass production bath with at least one edge roll proximate to an edge of the glass ribbon and in contact with an air side surface of the glass ribbon, the at least one edge roll configured to impose an outward force or inward force on the edge of the glass ribbon to control a width of the glass ribbon; receiving, with at least one processor, visual data from at least one camera positioned with a view of the glass ribbon; processing, with at least one processor, the visual data to determine a value of at least one dimension associated with the glass ribbon in a region proximate the at least one edge roll; determining, with at least one processor, that the value of the at least one dimension associated with the glass ribbon and/or an oscillational frequency of the value in the region proximate the at least one edge roll fails to satisfy a threshold value; and generating, with at least one processor, at least one alert associated with the at least one edge roll.

Clause 2: The method of clause 1, wherein the at least one dimension associated with the glass ribbon comprises a first width of the glass ribbon in the region proximate the at least one edge roll and/or a distance between the edge of the glass ribbon and the at least one edge roll.

Clause 3: The method of clause 1 or 2, wherein the stretching step comprises a plurality of edge rolls, and the at least one edge roll comprises a subset of the plurality of edge rolls.

Clause 4: The method of any of clauses 1-3, further comprising: in response to the at least one alert, maintenancing the at least one edge roll.

Clause 5: The method of any of clauses 1-4, further comprising: in response to the at least one alert, transmitting a control signal to the at least one edge roll configured to cause the at least one edge roll to execute a response action.

Clause 6: The method of clause 5, wherein the response action comprises an adjustment of at least one of: a rotation speed of the at least one edge roll, a location of the at least one edge roll in the glass ribbon, an angle of the at least one edge roll in the glass ribbon, a depth of the edge roll into the glass ribbon, and/or any combination thereof.

Clause 7: The method of any of clauses 1-6, further comprising: in response to the at least one alert, transmitting a control signal to a heating element located in the glass production bath to cause the heating element to execute a response action.

Clause 8: The method of any of clauses 1-7, wherein determining the value of at least one dimension associated with the glass ribbon in the region proximate the at least one edge roll comprises determining a first width of the molten glass in the region proximate the at least one edge roll and/or a distance between the edge of the glass ribbon and the at least one edge roll by: identifying, with at least one processor, a location of the at least one edge roll in the visual data; starting from the location of the at least one edge roll in the visual data, searching, with at least one processor, for a location of a first edge of the glass ribbon in the visual data by searching around the location of the at least one edge roll in the visual data; identifying, with at least one processor, the location of the first edge of the glass ribbon in the visual data by the searching; and based on the location of the first edge of the glass ribbon in the visual data, determining, with at least one processor, the width of the glass ribbon in the region proximate the at least one edge roll and/or the distance between the edge of the glass ribbon and the at least one edge roll.

Clause 9: The method of any of clauses 1-8, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by: receiving, with at least one processor, an input of at least one user-defined search area and/or user-defined characteristic object in the visual data; starting from the location of the at least one user-defined search area and/or user-defined characteristic object in the visual data, searching, with at least one processor, for a location of a first edge of the glass ribbon in the visual data by searching around the at least one user-defined search area and/or user-defined characteristic object in the visual data; identifying, with at least one processor, the location of the first edge of the glass ribbon in the visual data by the searching; and based on the location of the first edge of the glass ribbon in the visual data, determining, with at least one processor, the first width of the glass ribbon in the region proximate the at least one edge roll and/or the distance between the edge of the glass ribbon and the at least one edge roll.

Clause 10: The method of any of clauses 1-9, further comprising: determining, with at least one processor, that an image quality of the visual data fails to satisfy a threshold; and in response to determining that the image quality of the visual data fails to satisfy the threshold: (1) generating, with at least one processor, a notification associated with the at least one camera; and/or (2) cease generating control signals based on the visual data until the image quality of the visual data satisfies the threshold.

Clause 11: The method of any of clauses 1-10, further comprising: determining, with at least one processor, image quality of the visual data; and based on the determined image quality, automatically adjusting, with at least one processor, an image processing parameter and/or a camera setting associated with the at least one camera.

Clause 12: The method of any of clauses 1-11, further comprising: in response to the at least one alert, transmitting, with at least one processor, a control signal to the at least one edge roll and/or a heating element located in the glass production bath; measuring a response to the control signal by measuring a position of the edge of the glass ribbon and/or a distance between the edge of the glass ribbon and the at least one edge roll; comparing, with at least one processor, the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generating, with at least one processor, a further control signal for the at least one edge roll and/or the heating element based on the comparison.

Clause 13: A system for controlling glass production, comprising: a glass production bath comprising a bath of molten metal onto which a glass ribbon floats, the glass production bath comprising at least one edge roll proximate an edge of the glass ribbon, the at least one edge roll configured to impose an outward force or an inward force on the edge of the glass ribbon to control a width of the glass ribbon; and at least one processor configured to: receive visual data from at least one camera positioned with a view of the glass ribbon; process the visual data to determine a value of at least one dimension associated with the glass ribbon in the region proximate the at least one edge roll; determine that the value of the at least one dimension associated with the glass ribbon and/or an oscillational frequency of the value in the region proximate the at least one edge roll fails to satisfy a threshold value; and generate at least one alert associated with the at least one edge roll.

Clause 14: The system of clause 13, wherein the at least one dimension associated with the glass ribbon comprises a first width of the glass ribbon in the region proximate the at least one edge roll and/or a distance between the edge of the glass ribbon and the at least one edge roll.

Clause 15: The system of clause 13 or 14, wherein the glass production bath further comprises a plurality of edge rolls, and the at least one edge roll comprises a subset of the plurality of edge rolls.

Clause 16: The system of any of clauses 13-15, wherein in response to the at least one alert, the at least one edge roll is maintenanced.

Clause 17: The system of any of clauses 13-16, the at least one processor configured to: in response to the at least one alert, transmit a control signal to the at least one edge roll configured to cause the at least one edge roll to execute a response action.

Clause 18: The system of clause 17, wherein the response action comprises an adjustment of at least one of: a rotation speed of the at least one edge roll, a location of the at least one edge roll in the glass ribbon, an angle of the at least one edge roll in the glass ribbon, a depth of the at least one edge roll in an air side surface of the glass ribbon, and/or any combination thereof.

Clause 19: The system of any of clauses 13-18, the at least one processor configured to: in response to the at least one alert, transmit a control signal to a heating element located in the glass production bath to cause the heating element to execute a response action.

Clause 20: The system of any of clauses 13-19, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by: identifying a location of the at least one edge roll in the visual data; starting from the location of the at least one edge roll in the visual data, searching for a location of a first edge of the glass ribbon in the visual data by searching around the location of the at least one edge roll in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll.

Clause 21: The system of any of clauses 13-20, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by: receiving an input of at least one user-defined search area and/or user-defined characteristic object in the visual data; starting from the location of the at least one user-defined search area and/or user-defined characteristic object in the visual data, searching for a location of a first edge of the glass ribbon in the visual data by searching around the at least one user-defined search area and/or user-defined characteristic object in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll.

Clause 22: The system of any of clauses 13-21, the at least one processor configured to: determine that an image quality of the visual data fails to satisfy a threshold; and in response to determining that the image quality of the visual data fails to satisfy the threshold: (1) generate a notification associated with the at least one camera; and/or (2) cease generating control signals based on the visual data until the image quality of the visual data satisfies the threshold.

Clause 23: The system of any of clauses 13-22, the at least one processor configured to: determine image quality of the visual data; and based on the determined image quality, automatically adjust an image processing parameter and/or a camera setting associated with the at least one camera.

Clause 24: The system of any of clauses 13-23, the at least one processor configured to: in response to the at least one alert, transmit a control signal to the at least one edge roll and/or a heating element located in the glass production bath; measure a response to the control signal by measuring a position of the edge of the glass ribbon and/or a distance between the edge of the glass ribbon and the at least one edge roll; compare the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generate a further control signal for the at least one edge roll and/or the heating element based on the comparison.

Clause 25: A computer program product for controlling glass production, the computer program product comprising at least one non-transitory computer-readable medium including one or more instructions that, when executed by at least one processor, cause the at least one processor to: receive visual data from at least one camera positioned with a view of a glass ribbon floating in a glass production bath, the glass production bath comprising a molten metal onto which the glass ribbon floats, the glass production bath comprising at least one edge roll positioned proximate an edge of the glass ribbon, the at least one edge roll configured to impose an outward force or an inward force on the edge of the glass ribbon to control a width of the glass ribbon; process the visual data to determine a value of at least one dimension associated with the glass ribbon in a region proximate the at least one edge roll; determine that the value of the at least one dimension associated with the glass ribbon and/or an oscillational frequency of the value in the region proximate the at least one edge roll fails to satisfy a threshold value; and generate at least one alert associated with the at least one edge roll.

Clause 26: The computer program product of clause 25, wherein the at least one dimension associated with the glass ribbon comprises a first width of the glass ribbon in the region proximate the at least one edge roll and/or a distance between the edge of the glass ribbon and the at least one edge roll.

Clause 27: The computer program product of clause 25 or 26, wherein the glass production bath comprises a plurality of edge rolls, and the at least one edge roll comprises a subset of the plurality of edge rolls.

Clause 28: The computer program product of any of clauses 25-27, wherein in response to the at least one alert, the at least one edge roll is maintenanced.

Clause 29: The computer program product of any of clauses 25-28, the one or more instructions cause the at least one processor to: in response to the at least one alert, transmit a control signal to the at least one edge roll configured to cause the at least one edge roll to execute a response action.

Clause 30: The computer program product of clause 29, wherein the response action comprises an adjustment of at least one of: a rotation speed of the at least one edge roll, a location of the at least one edge roll in the glass ribbon, an angle of the at least one edge roll in the glass ribbon, a depth of the edge roll in the glass ribbon, and/or any combination thereof.

Clause 31: The computer program product of any of clauses 25-30, the one or more instructions cause the at least one processor to: in response to the at least one alert, transmit a control signal to a heating element located in the glass production bath to cause the heating element to execute a response action.

Clause 32: The computer program product of any of clauses 25-31, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by: identifying a location of the at least one edge roll in the visual data; starting from the location of the at least one edge roll in the visual data, searching for a location of a first edge of the glass ribbon in the visual data by searching around the location of the at least one edge roll in the visual data; identifying the location of the first edge of the glass ribbon in the visual data by the searching; and based on the location of the first edge of the glass ribbon in the visual data, determining the first width of the glass ribbon in the region proximate the at least one edge roll and/or the distance between the edge of the glass ribbon and the at least one edge roll.

Clause 33: The computer program product of any of clauses 25-32, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by: receiving an input of at least one user-defined search area and/or user-defined characteristic object in the visual data; starting from the location of the at least one user-defined search area and/or user-defined characteristic object in the visual data, searching for a location of a first edge of the glass ribbon in the visual data by searching around the at least one user-defined search area and/or user-defined characteristic object in the visual data; identifying the location of the first edge of the glass ribbon in the visual data by the searching; and based on the location of the first edge of the glass ribbon in the visual data, determining the width of the molten glass in the region proximate the at least one edge roll and/or the distance between the edge of the glass ribbon and the at least one edge roll.

Clause 34: The computer program product of any of clauses 25-33, the one or more instructions cause the at least one processor to: determine that an image quality of the visual data fails to satisfy a threshold; and in response to determining that the image quality of the visual data fails to satisfy the threshold: (1) generate a notification associated with the at least one camera; and/or (2) cease generating control signals based on the visual data until the image quality of the visual data satisfies the threshold.

Clause 35: The computer program product of any of clauses 25-34, the one or more instructions cause the at least one processor to: determine image quality of the visual data; and based on the determined image quality, automatically adjust an image processing parameter and/or a camera setting associated with the at least one camera.

Clause 36: The computer program product of any of clauses 25-35, the one or more instructions cause the at least one processor to: in response to the at least one alert, transmit a control signal to the at least one edge roll and/or a heating element located in the glass production bath; measure a response to the control signal by measuring a position of the edge of the glass ribbon and/or a distance between the edge of the glass ribbon and the at least one edge roll; compare the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll; generate a further control signal for the at least one edge roll and/or the heating element based on the comparison.

### BRIEF DESCRIPTION OF THE DRAWINGS

The disclosure will be described with reference to the following drawing figures wherein like reference numbers identify like parts throughout.

FIG. 1 shows a schematic diagram of a system for controlling glass production, according to some aspects of the disclosure;

FIG. 2 shows a schematic diagram of a perspective view of a system for controlling glass production, according to some aspects of the disclosure;

FIG. 3 shows a schematic diagram of a top view of a system for controlling glass production, according to some aspects of the disclosure;

FIG. 4 shows a schematic diagram of an edge roll, according to some aspects of the disclosure;

FIG. 5 shows a schematic diagram of a system for automatically determining a location of an edge of the glass ribbon, according to some aspects of the disclosure;

FIG. 6 shows a schematic diagram of a system for determining a location of an edge of the glass ribbon based on a user-defined search area, according to some aspects of the disclosure;

FIG. 7 shows a step diagram of a method for controlling glass production, according to some aspects of the disclosure; and

FIG. 8 shows a schematic diagram of example components of one or more devices, according to some non-limiting embodiments or aspects of the present disclosure.

### DETAILED DESCRIPTION

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple entities in a network environment, such as the internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device”, “a server,” “a processor,” and/or the like, as used herein, may refer to a previously recited device, server, and/or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Additionally, all documents, such as, but not limited to, issued patents and patent applications, referred to herein are to be considered to be “incorporated by reference” in their entirety.

The disclosure relates to methods, systems, and computer program products for controlling glass production.

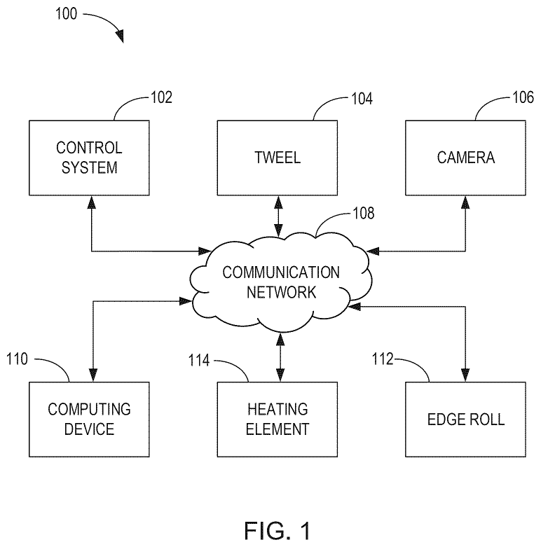

Referring now to FIG. 1, shown is a schematic diagram of an example system 100 for controlling glass production, according to some non-limiting embodiments or aspects. As shown in FIG. 1, system 100 may include control system 102, tweel 104, camera 106, computing device 110, edge roll 112, and/or heating element 114, which components may communicate over a communication network 108. Control system 102, tweel 104, camera 106, computing device 110, edge roll 112, and/or heating element 114 may interconnect (e.g., establish a connection to communicate) via wired connections, wireless connections, or a combination of wired and wireless connections.

Control system 102 may include one or more computing devices configured to communicate with tweel 104, camera 106, computing device 110, edge roll 112, and/or heating element 114 at least partly over communication network 108. Control system 102 may be configured to monitor the operation of edge roll 112 in system 100 and control at least one of tweel 104, edge roll 112, and/or heating element 114 based on the monitoring of the edge roll 112 to control the production of glass (e.g. the size and/or shape of a glass ribbon produced thereby). Control system 102 may include or be in communication with edge roll 112 and/or heating element 114 and/or camera 106. Control system 102 may be located on-site with the environment that includes edge roll 112, camera 106, melting tank, and bath, or may be positioned remotely from said environment.

Tweel 104 may include or be associated with one or more computing devices configured to communicate with control system 102, camera 106, computing device 110, edge roll 112, and/or heating element 114 at least partly over communication network 108. Tweel 104 may be configured to open and close, to control the flow of molten glass in a manufacturing process. Tweel 104 may communicate with and/or be included in control system 102. Control system 102 may transmit a control signal to tweel 104 to cause tweel 104 to open and/or close.

Camera 106 may include one or more processors that are configured to communicate with control system 102, tweel 104, computing device 110, edge roll 112, and/or heating element 114 at least partly over communication network 108. Camera 106 may be configured to capture visual data (e.g., optical data that is visible (detectable) to the camera 106, which may or not be in the visual spectrum of a human viewer) of a molten glass manufacturing process. Camera 106 may communicate with and/or be included in control system 102. Camera 106 may include one or more cameras that are positioned with the same or different views of edge roll 112, the melting tank, bath, and/or downstream process of the molten glass manufacturing process. Control system 102 may transmit a control signal to camera 106 to cause camera 106 to turn on, turn off, zoom in, zoom out, move (e.g., change views), and the like.

Computing device 110 may include one or more processors that are configured to communicate with control system 102, tweel 104, camera 106, edge roll 112, and/or heating element 114 at least partly over communication network 108. Computing device 110 may be associated with a user that is monitoring the process for controlling glass production. Computing device 110 may include a display for displaying one or more portions of visual data generated by camera 106. Computing device 110 may further include one or more input components (e.g., a mouse) to input user-defined search areas to guide control system's 102 automated processing of the visual data. Computing device 110 may be located on-site with the environment that includes the edge roll 112, melting tank, camera 106, and bath, or may be positioned remotely from said environment.

Edge roll 112 may include or be associated with one or more computing devices configured to communicate with control system 102, tweel 104, camera 106, computing device 110, and/or heating element 114 at least partly over communication network 108. Edge roll 112 may be in contact with (e.g., inserted into) an air side surface of a glass ribbon on a glass production bath, and edge roll 112 may be configured to stretch the glass ribbon, such as by imposing an outward force and/or an inward force on the edge of the glass ribbon to control a width of the glass ribbon. Edge roll 112 may communicate with and/or be included in control system 102. For example, control system 102 may transmit a control signal to edge roll 112 to cause edge roll 112 to move in a predetermined manner.

Heating element 114 may include or be associated with one or more computing devices configured to communicate with control system 102, tweel 104, camera 106, computing device 110, and/or edge roll 112 at least partly over communication network 108. Heating element 114 may be located in a glass production bath. Heating element 114 may be configured to heat or cool to change the temperature of the glass production bath. Heating element 114 may communicate with and/or be included in control system 102. For example, control system 102 may transmit a control signal to heating element 114 to cause heating element 114 to heat or cool.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, control system 102 may perform one or more steps, independently or in conjunction with edge roll 112 and one or more cameras 106, to provide a system for automatic edge roll 112 control in molten glass production. For example, control system 102 may receive visual data (e.g., optical signals that may or may not be in the spectrum of human perception, and that may or may not be pre-processed) from at least one camera 106 positioned with a view (e.g., a detectable area) of a molten glass flow (e.g., heated to >1000° C.) that is spreading from a melting tank (e.g., a heated container, such as associated with a furnace) into a bath (e.g., an insulated container) containing molten metal (e.g., tin). Control system 102 may further process (e.g., filter, combine, convert, modify, transform, and/or analyze, etc.) the visual data to determine a value (e.g., a measurement, such as in pixels, inches, centimeters, degrees, or other quantitative measure) of at least one dimension of the molten glass flow and/or glass ribbon (e.g., width of glass flow, length of glass flow, depth of glass flow, angle of spread of glass flow, spread rate of the glass flow, etc.) and/or at least one dimension of edge roll 112.

With reference to determining the value of the at least one dimension, control system 102 may determine a number of image pixels in the visual data between an edge of the glass flow and/or glass ribbon and a reference point (e.g., another edge of the glass, an edge of the bath, the same edge of the glass flow measured at a different time point, etc.) and/or edge roll 112 (e.g., machine head thereof) and converting the number of pixels to a distance unit based on an established calibration of camera 106. While physical dimensions may be determined from the visual data based on real measurements of the furnace and camera installation dimensions, it will be appreciated that non-physical dimension values may be used if an arbitrary reference value is provided.

With reference to processing, control system 102 may first modify one or more parameters of the visual data based on the environment of the melting tank and/or bath and/or edge roll 112. For example, control system 102 may determine a heat output (e.g., British thermal units (BTUs), temperature, joules, etc.) of a heat source (e.g., one or more furnace heating elements 114) associated with the melting tank or in a region of edge roll 112. Control system 102 may then adjust at least one parameter of the visual data based on the heat output of the heat source. The at least one parameter may include, but is not limited to, exposure (e.g., a representation of the amount of light that reaches camera's 106 sensor), gain (e.g., a representation of the relationship between the number of electrons acquired on an image sensor and the analog-to-digital units (ADUs) that are generated), and position (e.g., an area or location of a field of view). By way of further example, if the heat output of a heat source (e.g., for the melting tank, for the bath, etc.) is high, additional light may be produced in the view of camera 106, and so camera's 106 exposure may be lowered to account for the additional illumination. Modifications to the parameters of the visual data may be made at camera 106 before the visual data is generated or may be made in the visual data itself after generation by camera 106.

With further reference to processing, control system 102 may use an edge detection process when processing the visual data. For example, control system 102 may convert the visual data from color to grayscale and execute an edge detection process (e.g., based on the intensity or shade of areas within visual data, such as where one subarea having a first shade abuts another subarea having a second shade). The edge detection process may identify a first edge of the molten glass flow and a second edge of the molten glass flow. Where the at least one dimension is a maximum width of the molten glass flow, the first edge may be opposite the second edge, on the sides of the molten glass flow, perpendicular to the direction of flow. Control system 102 may then calculate the maximum width between the first edge and the second edge, to determine the value of the at least one dimension of the molten glass flow. The edge detection process may identify an edge (e.g., an interface) where edge roll 112 contacts the molten glass flow. To further modify the edge detection process, control system 102 may receive an input of at least one user-defined search area (e.g., a path in the visual data along which control system 102 is directed to perform a search for an edge), such as from computing device 110 of a user. Control system 102 may automatically, procedurally search along the at least one user-defined search area until the first edge and the second edge are identified.

In some non-limiting embodiments or aspects, control system 102 may compare the value of the at least one dimension of the molten glass flow and/or edge roll 112 to at least one predetermined threshold value (e.g., a preset value for the measured dimension that is associated with an amount or flow rate of the molten glass flow, such as the glass flow being too little, too much, or expected; a preset value of a measured dimension of edge roll 112 with respect to the molten glass flow). Control system 102 may, in response to the value of the at least one dimension of the molten glass flow and/or edge roll 112 satisfying at least one predetermined threshold value, generate at least one control signal (e.g., one or more discrete pulse signals and/or continuous (e.g., analog) transmissions of a signal configured to modify operation) to the edge roll 112 and/or heating element 114 (e.g., to control direction of movement, magnitude of movement, temperature of element, and/or the like).

In some non-limiting embodiments or aspects, control system 102 may perform the foregoing steps in a repeated process, for ongoing automatic control of the edge roll 112. For example, control system 102 may repeatedly execute a series of steps to continue to monitor the glass production and edge roll 112. The series of steps may include receiving new visual data from the at least one camera 106, processing the new visual data to determine a new value of the at least one dimension of the molten glass flow and/or edge roll 112, and, in response to the new value of the at least one dimension satisfying the at least one predetermined threshold value, generating a new control signal to edge roll 112 and/or heating element 114. The above-described series of steps may be repeatedly executed for a time interval until control system 102 receives an instruction to stop the loop (e.g., from computing device 110 of a user).

With reference to control signals, control system 102 may be configured to modify the length, number, and/or frequency of the control signals. For example, control system 102 may determine a length (e.g., milliseconds) of the at least one first control signal that is generated based on a difference between the value of the at least one dimension and the at least one predetermined threshold value. To illustrate, the greater the difference, the longer the at least one control signal may be. Control system 102 may control each signal in a plurality of control signals to have the same length or different lengths. By way of further example, control system 102 may determine a number of signals (e.g., being 1 or more) for the at least one first control signal that are generated based on a difference between the value of the at least one dimension and the at least one predetermined threshold value. To illustrate, the greater the difference, the more control signals may be generated.

In some non-limiting embodiments or aspects, control system 102 may perform other steps, beside automatic edge roll 112 and/or heating element 114 control, based on the processing of the visual data. For example, control system 102 may detect a process anomaly (e.g., an abnormality in the expected and/or accepted manufacturing process) based at least partly on the processing of the visual data. In response to detecting the process anomaly, control system 102 may activate an alarm (e.g., physical and/or virtual) to signal to an operator to respond to (e.g., remove, address, etc.) the process anomaly. The alarm may be a visual, audible, and/or other sensory alarm that is associated with control system 102, tweel 104, camera 106, computing device 110, edge roll 112, heating element 114, or another device in the environment, such as melting tank, bath, and/or the like. By way of further example, control system 102 may generate and communicate a message to computing device 110 configured to cause computing device 110 to generate a visual and/or auditory alert for a user. Additionally or alternatively, control system 102 may, in response to detecting the process anomaly (e.g., an equipment failure), change a control mode of edge roll 112 and/or heating element 114 from an automatic mode (e.g., in which control system 102 fully operates edge roll 112 and/or heating element 114) to a semi-automatic mode (e.g., in which control system 102 and a user each partially operate edge roll 112 and/or heating element 114) or a manual mode (e.g., in which a user fully operates edge roll 112 and/or heating element 114).

With reference to detected anomalies, the detected process anomaly may be the presence of debris (e.g., one or more unexpected objects) in a manufacturing area containing the molten glass flow (e.g., proximate edge roll 112). Control system 102 may detect the presence of the debris in a field of view of camera 106 during the processing of the visual data (e.g., by detecting an object that is proximal to the camera 106, such as on the lens, or a shape of an object that is not expected by control system 102, and/or the like). The detected process anomaly may also be an equipment failure (e.g., a malfunction of one or more devices in the manufacturing area containing the molten glass flow, such as edge roll 112). For example, control system 102 may compare the value of the at least one dimension of the molten glass flow and/or edge roll 112 to at least one expected value (e.g., comparing a measured width to an expected width). For example, control system 102 may compare oscillation frequency characteristics of the value to an expected (e.g., historical and/or baseline) value. Control system 102 may then detect the equipment failure based on a difference between the value of the at least one dimension and at least one expected value (e.g., an expected value of the dimension). For example, if edge roll 112 was transmitted a prior control signal but the change in molten glass flow does not reflect the expected change based on the prior control signal, then control system 102 may infer that there is an equipment failure preventing edge roll 112 from operating as instructed.

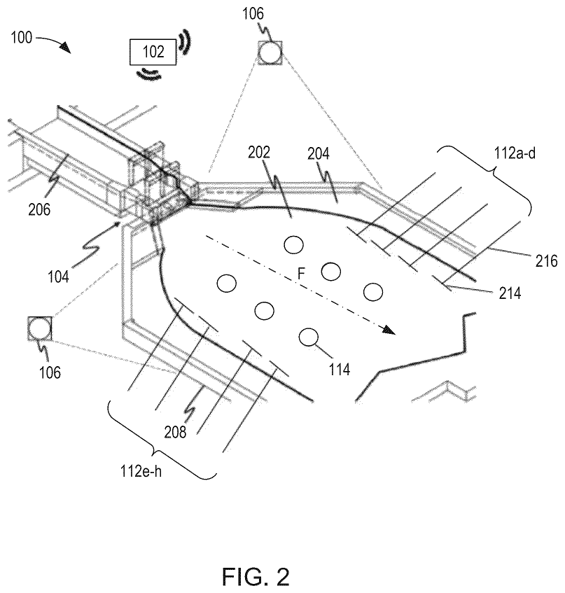

Referring now to FIG. 2, shown is a schematic diagram of a system 100 for controlling glass production, according to some non-limiting embodiments or aspects of the present disclosure. The schematic diagram of FIG. 2 is a perspective view of a glass manufacturing float line process. As shown, system 100 may include a glass production bath 208 that contains molten metal 204 (e.g., tin). System 100 may also include melting tank 206, tweel 104, camera 106 (e.g., two or more cameras 106), and control system 102. Glass may be melted in melting tank 206 and poured into bath 208 onto molten metal 204 as molten glass flow 202 that floats on bath 208 (e.g., on molten metal 204 therein) to form a glass ribbon. Molten glass flow 202 may be carried in the direction indicated by arrow F. Visual data may be generated at each camera 106, and each camera 106 may have a view of molten glass flow 202 that spreads from melting tank 206 into bath 208. Each camera 106 may have a view of one or more edge roll 112a-h in the system 100. Each edge roll 112a-h may comprise a machine head 214 and a barrel 216. Barrel 216 may have a first end remote from the glass ribbon and a second end proximate to the glass ribbon (and/or inserted into glass ribbon). Machine head 214 may be arranged at the second end of barrel 216.

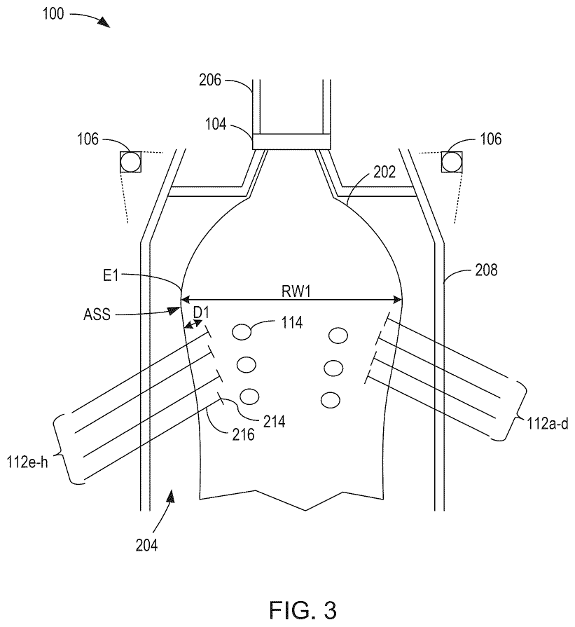

With further reference to FIG. 2, control system 102 may be communicatively connected to each camera 106. Control system 102 may be positioned remotely from melting tank 206, bath 208, and cameras 106. Control system 102 may provide edge roll 112a-h and/or heating element 114 control for multiple molten glass manufacturing environments for a plurality of edge rolls 112a-h and/or heating elements 114 associated each with their own melting tank 206 and bath 208. Control system 102 may be communicatively connected to each camera 106 and may receive the visual data from each camera 106 corresponding to said camera's 106 view. Control system 102 may process the visual data from one or more cameras 106 in order to determine a value of at least one dimension of the molten glass flow 202 and/or one or more edge rolls 112a-h. See FIG. 3 for further detailed discussion on one or more dimensions that may be determined for molten glass flow 202 and/or one or more edge rolls 112a-h. It will be appreciated that control system 102 may use visual data from as few as one camera 106, if a single camera's 106 field of view captures visual data of a sufficient amount of molten glass flow 202 and/or one or more edge rolls 112a-h by which a dimension can be determined. Alternatively, control system 102 may use visual data from more than one camera 106 and use visual data from the cameras 106 to determine a dimension of molten glass flow 202 and/or one or more edge rolls 112a-h. In using visual data from multiple cameras 106, control system 102 may combine the visual data from each camera 106 in the processing of the visual data.

With further reference to FIG. 2, control system 102 may compare the value of the at least one dimension of molten glass flow 202 and/or one or more edge rolls 112a-h to a predetermined threshold value. In response to the value of the at least one dimension of molten glass flow 202 and/or one or more edge rolls 112a-h satisfying the at least one predetermined threshold value, control system 102 may generate and transmit at least one first control signal to one or more edge rolls 112a-h and/or heating element 114 to cause a control action thereon. Control system 102 may further detect process anomalies based on the processing of the visual data and perform one or more steps in response to detection of process anomalies, including activating an alarm, changing a control mode of one or more edge rolls 112a-h and/or heating element 114, and/or the like.

Referring now to FIG. 3, shown is a schematic diagram of a system 100 for controlling glass production, according to some non-limiting embodiments or aspects of the present disclosure. The schematic diagram of FIG. 3 is a top-down view of a glass manufacturing float line process and corresponds to the same system 100 as shown in FIG. 2. The illustrated area of the glass manufacturing float line process shown in FIG. 3 may be substantially captured in visual data by one or more cameras 106. Cameras 106 may generate visual data of molten glass flow 202 on molten metal 204 in bath 208 and/or visual data of one or more edge rolls 112a-h.

In some non-limiting embodiments or aspects, control system 102 may process the visual data to determine a value of one or more dimensions D1, E1, RW1 of molten glass flow 202, which forms the glass ribbon having an air side surface (ASS). For example, control system 102 may process the visual data to determine a value of a first dimension as a ribbon width RW1 of the glass ribbon. The ribbon width RW1 may be a maximum width of molten glass flow 202 as shown in FIG. 3 or any other width of molten glass flow 202 along a length of bath 208. To do so, control system 102 may use edge detection techniques to identify edges (e.g., E1) of the glass ribbon from the visual data. Control system 102 may determine a distance between the edges to determine a value of ribbon width RW1. When calculating a maximum width, control system 102 may identify an extremum on each edge e.g., E₁ of glass ribbon that is furthest from a center axis of molten glass flow 202 and calculate a distance between the extrema. Control system 102 may compare the value of ribbon width RW1 to a predetermined threshold value and generate one or more control signals to control one or more edge rolls 112a-h and/or heating element 114, as needed.

Control system 102 may determine a distance between glass ribbon edge E1 and a machine head 214 of one or more edge rolls 112 a-h D1 (e.g., 112e of FIG. 3). Control system 102 may compare the value of D1 to a predetermined threshold value and generate one or more control signals to control one or more edge rolls 112a-h and/or heating element 114, as needed.

Referring again to FIGS. 2 and 3, glass melt in melting tank 206 may be poured on molten metal 204 in bath 208. The glass melt floating on the molten metal 204 may form a molten glass flow 202 flowing in direction F to form a glass ribbon. The glass ribbon may contact one or more edge rolls 112a-h, such that the one or more edge rolls 112a-h contains a machine head 214 arranged in the glass ribbon. The one or more edge rolls 112a-h may be arranged proximate to the edge E1 of the glass ribbon and in contact with an air side surface ASS of the glass ribbon. In some non-limiting embodiments or aspects, a plurality of edge rolls 112a-h is provided, with each of the edge rolls 112a-h inserted into the glass ribbon at a different point along the length of bath 208.

One or more edge rolls 112a-h may stretch the glass ribbon in bath 208 in any suitable manner. For example, one or more edge rolls 112a-h may impose an outward or inward force on edge E1 of the glass ribbon. The force imposed by one or more edge rolls 112a-h may control ribbon width RW1 at one or more points along a length of bath 208. For example, one or more edge rolls 112a-h may exert an inward force on edge E1 of the glass ribbon to narrow ribbon width RW1. For example, one or more edge rolls 112a-h may exert an outward force on edge E1 of the glass ribbon to widen ribbon width RW1. One or more edge rolls 112a-h may be controlled by control system 102 to exert the outward and/or inward force that causes the glass ribbon to obtain the size, shape, design, and the like desired for the glass sheet intermediate and/or end product. For example, control system 102 may transmit one or more control signals to one or more edge rolls 112a-h to control movement thereof, and therefore the force exerted on the glass ribbon thereby. Each of the one or more edge rolls 112a-h may exert its force on the glass ribbon at the location in which the one or more edge rolls 112a-h is located along the length of bath 208. Therefore, one or more of the one or more edge rolls 112a-h may be specifically selected to exert a force on a specific location of the glass ribbon compared to the other of the one or more edge rolls 112a-h based on a desired and/or predetermined shape of the glass ribbon in that specific location.

In some non-limiting embodiments or aspects, a plurality of edge rolls 112a-h is provided, with each of the edge rolls 112a-h inserted into the glass ribbon at a different point along the length of bath 208. Of the plurality of edge rolls 112a-h, a subset thereof may impose an outward force or inward force on edge E1 of the glass ribbon to control a width of the glass ribbon, while remaining of the plurality of edge rolls 112a-h do not exert any force thereon. This may enable the system 100 to widen and/or narrow certain regions of the glass ribbon to achieve a desired width gradient along the length of the bath 208.

With continued reference to FIGS. 2 and 3, one or more cameras 106 positioned with a view of the glass ribbon may collect visual data of the environment. The cameras 106 may be positioned with views of edge rolls 112a-h, melting tank 206, bath 208, and/or downstream process of the molten glass manufacturing process. Control system 102 may communicate with cameras 106. For example, cameras 106 may transmit the collected visual data to control system 102. For example, control system 102 may transmit a control signal to camera 106 to cause camera 106 to, for example, turn on, turn off, zoom in, zoom out, move (e.g., change views), and the like.

In response to receiving visual data from cameras 106, control system 102 may process the visual data. Processing the visual data may comprise isolating one or more frames from one or more cameras 106. Processing the visual data may comprise combining frames from different cameras 106, such as frames from different cameras but having a same timestamp. Processing the visual data may comprise zooming in and/or out on specific frames provided by the cameras 106. Processing of the visual data may be configured to determine a value of at least one dimension associated with the glass ribbon in a region proximate one or more of edge rolls 112a-h.

Any dimension that informs on the working state of one or more of edge rolls 112a-h may be determined. For example, the dimension may comprise a value (e.g., an absolute value) of the glass ribbon width at a location along a length of bath 208 (e.g., RW1) and/or a distance between the ribbon edge E1 and a location of one or more of edge rolls 112a-h (e.g., a machine head 214 of one or more of edge rolls 112a-h)(e.g., D1).

For example, the dimension may comprise a distance between the ribbon edge and a machine head of one or more of edge rolls 112a-h. Control system 102 may ensure, based on this dimension, that a distance between the ribbon edge E1 and the machine head 214 is maintained above a threshold distance. Maintaining the distance between the ribbon edge E1 and the machine head 214 is maintained above a threshold distance may prevent one or more of edge rolls 112a-h from losing its grip on the glass ribbon and/or to reduce waste and/or save material.

In some non-limiting embodiments or aspects, the same dimension may be determined over time by control system 102 analyzing the visual data from camera 106 over time to see how the same dimension changes as a function of time.

In response to determining a value of at least one dimension associated with the glass ribbon in a region proximate one or more of edge rolls 112a-h, control system 102 may determine whether the value of the dimension associated with the glass ribbon and/or an oscillational frequency of the value in the region proximate one or more of edge rolls 112a-h satisfies a threshold value. The oscillation frequency of the value may refer to how the same dimension changes over a period of time. Frequency spectrum analysis of such oscillation can reveal/indicate early signs of machine failure of edge rolls or entrapment of foreign objects.

The threshold value may correspond to a value that indicates a health of the operation of one or more of edge rolls 112a-h. The determination that the value of the dimension and/or the oscillation frequency thereof in the region proximate one or more of edge rolls 112a-h satisfies the threshold may indicate that one or more of edge rolls 112a-h is in satisfactory operational health. The determination that the value of the dimension and/or the oscillation frequency thereof in the region proximate one or more of edge rolls 112a-h fails to satisfy the threshold may indicate that one or more of edge rolls 112a-h is not in satisfactory operational health (e.g. is broken, is malfunctioning, needs replaced, is obstructed, and/or the like).

In some non-limiting embodiments or aspects, in response to determining that the value of the dimension and/or the oscillation frequency thereof in the region proximate one or more of edge rolls 112a-h fails to satisfy the threshold, control system 102 may automatically generate at least one alert associated with one or more of edge rolls 112a-h. Generating the alert may comprise the control system activating an alarm (e.g., physical and/or virtual) to signal to an operator to respond to the operational health of one or more of edge rolls 112a-h. The alarm may be a visual, audible, and/or other sensory alarm. In some non-limiting embodiments or aspects, the alarm may be activated in association with a user (e.g., operator) computing device (e.g., computing device 110), such as displaying an alarm on a user interface thereof and/or emitting an alarm through a speaker thereof. It will be appreciated that any suitable arrangement for alerting an operator of the condition of one or more of edge rolls 112a-h may be used in connection with the present disclosure.

In some non-limiting embodiments or aspects, in response to the alert, one or more of edge rolls 112a-h may be maintenanced. Maintenancing one or more of edge rolls 112a-h may include at least one of the following: replacing one or more of edge rolls 112a-h, replacing a component of one or more of edge rolls 112a-h, cleaning one or more of edge rolls 112a-h, cleaning an environment of one or more of edge rolls 112a-h (e.g., to remove a foreign object), adjusting a position of one or more of edge rolls 112a-h, removing one or more of edge rolls 112a-h, adding one or more of edge rolls 112a-h, conducting further testing on the operational health of one or more of edge rolls 112a-h, and/or any combination thereof. The maintenance step may be automatically performed by a component of system 100, performed by an operator, and/or any combination thereof.

In some non-limiting embodiments or aspects, in response to the alert, one or more control signals may be transmitted (e.g. from control system 102) to one or more of edge rolls 112a-h. The control signal may cause one or more of edge rolls 112a-h to execute a response action to address the operational health issue identified by control system 102. The response action may comprise an adjustment of at least one of: a rotation speed of one or more of edge rolls 112a-h, a location of one or more of edge rolls 112a-h in the glass ribbon, an angle of one or more of edge rolls 112a-h in the glass ribbon, a depth of one or more of edge rolls 112a-h into the glass ribbon, and/or any combination thereof.

In some non-limiting embodiments or aspects, in response to the alert, one or more control signals may be transmitted (e.g. from control system 102) to heating element 114 to cause heating element 114 to execute a response action. Heating element 114 may be located in bath 208 and be configured to heat or cool the material of bath 208. The response action may comprise activating one or more heating element 114, deactivating one or more heating element 114, increasing a temperature of one or more heating element 114, decreasing a temperature of one or more heating element 114, and/or any combination thereof. Adjusting the heating element 114 may address a potential bath issue revealed by the tracked movement of ribbon edges/positions. For example, if the tracking results show that the ribbon is leaning towards one side of the bath 208 (e.g., the center of the ribbon is not in the center of the bath), it may indicate the heat from the left and right side of the bath is not balanced. Therefore, proper adjustment of the heating element 114 may be executed in response.

In some non-limiting embodiments or aspects, in response to the alert, control system 102 may transmit the control signal to one or more of edge rolls 112a-h and/or one or more heating element 114 located in bath 208. The response to the control signal may be measured by control system 102. Control system 102 may measure the response to the control signal by measuring a position of edge E1 of the glass ribbon and/or a distance between edge E1 of the glass ribbon and edge rolls 112a-h after the action corresponding to the control signal is executed. This response to the control signal may be measured using the visual data and/or one or more sensor configured to make such measurements. For example, the measured position of edge E1 of the glass ribbon and/or a distance between edge E1 of the glass ribbon and edge rolls 112a-h after the action corresponding to the control signal is executed may be compared to historical data regarding the same. Control system 102 may store historical data regarding processes of system 100. Based on the comparison, control system 102 may generate a further control signal for one or more of edge rolls 112a-h and/or one or more heating element 114. The further control signal may comprise a different instruction, a new instruction, a repeat instruction, a previous instruction, a change in magnitude of an instruction, and/or the like. The comparison may additionally or alternatively enable control system 102 to identify one or more component of system 100 (e.g., one or more of edge rolls 112a-h and/or one or more heating element 114) requiring maintenance.

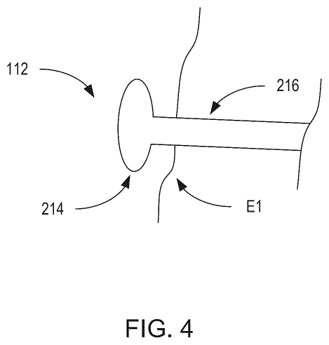

Referring to FIGS. 4-6, a schematic diagram of an edge roll 112 is shown, according to some aspects of the disclosure. Edge roll 112 may comprise a machine head 214 inserted into an air side surface of the glass ribbon (e.g., into edge E1 thereof), such that the machine head 214 is arranged in the glass ribbon. Edge roll 112 may comprise an elongated barrel 216 connected to and extending from machine head 214. Barrel 216 may have a first end remote from the glass ribbon and a second end proximate to the glass ribbon (and/or inserted into glass ribbon). Machine head 214 may be arranged at the second end of barrel 216. Machine head 214 of edge roll 112 may impose an outward force or inward force on the edge E1 of the glass ribbon to control a width of the glass ribbon, and the location of machine head 214 in the glass ribbon may be controlled at least partially by barrel 216.

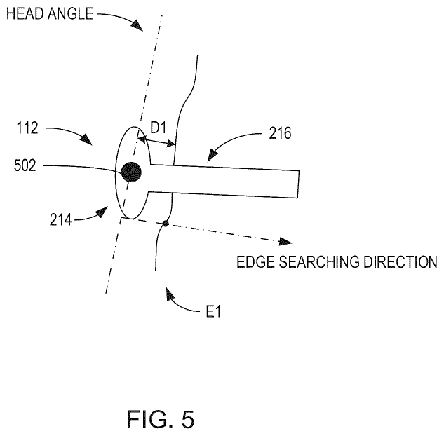

Referring to FIG. 5, a schematic diagram of a system for automatically determining a location of an edge E1 of the glass ribbon is shown, according to some aspects of the disclosure. Control system 102 (from FIG. 1) may identify a location of edge roll 112 in the visual data received from camera 106 (from FIG. 1). For example, control system 102 may identify a location of machine head 214 in the visual data and generate a marker 502 that represents a location of the detected machine head 214 in the visual data. The location of machine head 214 in the visual data may be automatically detected by control system 102, such as by a machine learning model capable of image detection and trained to detect objects in visual data.

In some non-limiting embodiments or aspects, the location of the machine head 214 in the visual data may be automatically detected by control system 102 at the beginning of a glass production process such that control system 102 may track a position of machine head 214 during production and search for edge E1 from the tracked position of machine head 214 and/or monitor position of machine head 214 and/or edge E1. Position of machine head 214 may be tracked in real-time by control system 102 based on receiving visual data from camera 106 during the production process. Position of machine head 214 (or other object) may be tracked in real-time by control system 102, relative to receipt of the visual data from camera 106 (e.g., in real-time, in near real-time, during the event, as soon as practically available after the event, during processing and/or communication of messages related to the event and/or the like). For example, the term “real-time” may refer to performance of a task or tasks during another process or before another process is completed.

Based on the detected location of the edge roll 112 (e.g., machine head 214 thereof), control system 102 may automatically start searching the visual data for a location of edge E1 of the glass ribbon by starting from marker 502. For example, control system 102 (e.g., an image detection model thereof) may start from the location of marker 502 and automatically search the visual data around the location of the marker 502 to find edge E1. Starting the search for edge E1 from marker 502 may enable the image detection model to identify edge E1 faster and using fewer processing resources. By the searching, control system 102 (e.g., image detection model thereof) may automatically identify the location of edge E1 of the glass ribbon. Based on marker 502 and an angle of machine head 214, control system may identify an edge searching direction that represents a direction in which control system expects edge E1 to be located. Control system 102 may automatically search in edge searching direction starting from marker 502 to enable the image detection model to identify edge E1 faster and using fewer processing resources.

Based on the automatically detected location of edge E1 in the visual data, control system 102 may automatically determine the width of the glass ribbon RW1 in the region proximate edge roll 112 and/or the distance D1 between the edge E1 of the glass ribbon and the edge roll 112, thereby determining the value of the dimension, as previously described. From the determined dimension, control system 102 may determine whether the value of the dimension associated with the glass ribbon and/or an oscillational frequency of the value in the region proximate the at least one edge roll 112 satisfies a threshold value, as previously described.

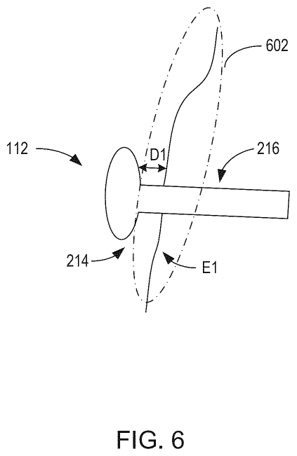

Referring to FIG. 6 a schematic diagram of a system for automatically determining a location of an edge E1 of the glass ribbon based on a user-defined search area is shown, according to some aspects of the disclosure. Control system 102 (from FIG. 1) may identify a location of edge roll 112 in the visual data received from camera 106 (from FIG. 1) based on a user-defined search area. The visual data may be displayed on a user device (e.g., computing device 110 of FIG. 1). A user may input to user device a user-defined search area 602 and/or a user-defined characteristic object (similar to marker 502 but at least partially user defined and/or generated) in the visual data. User may input the user-defined search area 602 and/or a user-defined characteristic object using an input component of computing device 110, such as a mouse, a stylus, and/or touch screen thereof.

The user-defined search area 602 may comprise an area of the visual data identified by the user that represents where the user directs the control system 102 to begin its automated search for edge E1. The user-defined search area 602 may comprise an area as shown in FIG. 6 but may additionally or alternatively comprise a search line and/or a search point.

The user-defined characteristic object may comprise the user identification of a location (e.g., a point) of a specific object in the visual data, such as a specific location of machine head 214.

In some non-limiting embodiments or aspects, a user may identify and input the user-defined characteristic object (e.g., machine head 214) (and/or user-defined search area 602) at the beginning of a glass production process such that control system 102 may track a position of machine head 214 during production and search for edge E1 from the tracked position of machine head 214 and/or monitor position of machine head 214 and/or edge E1. Position of the user-defined characteristic object may be tracked in real-time by control system 102 based on receiving visual data from camera 106 during the production process. Position of the user-defined characteristic object may be tracked in real-time by control system 102, relative to receipt of the visual data from camera 106 (e.g., in real-time, in near real-time, during the event, as soon as practically available after the event, during processing and/or communication of messages related to the event and/or the like). For example, the term “real-time” may refer to performance of a task or tasks during another process or before another process is completed.

Based on the user-defined search area 602 and/or user-defined characteristic object, control system 102 may automatically start searching the visual data for a location of edge E1 of the glass ribbon by starting from user-defined search area 602 and/or user-defined characteristic object. For example, control system 102 (e.g., an image detection model thereof) may start from the location of user-defined search area 602 and/or user-defined characteristic object and automatically search the visual data around the location of user-defined search area 602 and/or user-defined characteristic object to find edge E1. Starting the search for edge E1 from user-defined search area 602 and/or user-defined characteristic object may enable the image detection model to identify edge E1 faster and using fewer processing resources. By the searching, control system 102 (e.g., image detection model thereof) may automatically identify the location of edge E1 of the glass ribbon.

Based on the automatically detected location of edge E1 in the visual data, control system 102 may automatically determine the width of the glass ribbon RW1 in the region proximate edge roll 112 and/or the distance D1 between the edge E1 of the glass ribbon and the edge roll 112, thereby determining the value of the dimension, as previously described. From the determined dimension, control system 102 may determine whether the value of the dimension associated with the glass ribbon and/or an oscillational frequency of the value in the region proximate the at least one edge roll 112 satisfies a threshold value, as previously described.

Referring again to FIGS. 2 and 3, image quality of the visual data may impact control system 102. For example, control system 102 may receive visual data from camera 106. Control system 102 may determine that an image quality of the visual data fails to satisfy a threshold. The image quality of the visual data failing to satisfy a threshold may indicate that the visual data is not sufficiently clear, such that measurements made using the visual data may not be reliable. The image quality may fail to satisfy the threshold for any number of reasons, such as for the image no longer being available at all, the image being pixilated or otherwise unclear, the image being of the wrong section of system 100 (e.g., camera 106 being bumped), and the like.

In response to determining that the image quality of the visual data fails to satisfy the threshold, control system 102 may generate a notification associated with camera 106. Generating the notification may comprise control system 102 activating an alarm (e.g., physical and/or virtual) to signal to an operator to respond to the operational health of camera 106. The alarm may be a visual, audible, and/or other sensory alarm. In some non-limiting embodiments or aspects, the alarm may be activated in association with a user (e.g., operator) computing device (e.g., computing device 110), such as displaying an alarm on a user interface thereof and/or emitting an alarm through a speaker thereof. It will be appreciated that any suitable arrangement for alerting an operator of the condition of camera 106 may be used in connection with the present disclosure. The notification associated with the camera 106 may cause maintenance of camera 106.

Additionally or alternatively, in response to determining that the image quality of the visual data fails to satisfy the threshold, control system 102 may cease generating control signals based on the visual data until the image quality of the visual data satisfies the threshold. As previously described, control signals may be transmitted by control system 102 to edge roll 112a-h and/or heating element 114 (or any other component of system 100) to cause a response action to be executed based on the visual data. However, such control signals based on faulty visual data may be at least temporarily ceased to avoid a response action from being executed based on faulty visual data. Control signals based on the visual data may be automatically resumed when the image quality of the visual data is again determined to satisfy the threshold.

With continued reference to FIGS. 2 and 3, control system 102 may determine an image quality of the visual data from camera 106. Based on the determined image quality, control system 102 may automatically adjust an image processing parameter and/or a camera setting associated with camera 106. Adjusting an image processing parameter and/or a camera setting may compensate for external disturbances to camera 106 (and the image quality resulting therefrom). An image processing parameter may include at least one of the following: brightness, contrast, color interpolation, filtering kernel size, filtering iteration, noise reduction thresholds, and/or any combination thereof. A camera setting may include at least one of the following: aperture, shutter speed, ISO, white balance, exposure, focus, frame rate, and/or any combination thereof.

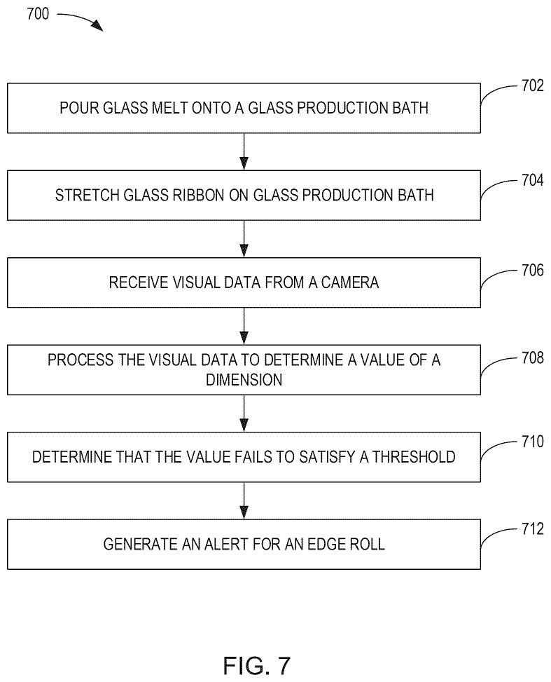

Referring to FIG. 7, a method 700 for controlling glass production is shown according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At a step 702, the method 700 may include pouring a glass melt onto a glass production bath (e.g., bath 208) of molten metal (e.g., molten metal 204) onto which the glass melt floats (e.g., as molten glass flow 202) to form a glass ribbon.

At a step 704, the method 700 may include stretching the glass ribbon on the glass production bath (e.g., bath 208) with at least one edge roll (e.g., edge rolls 112a-h) proximate to an edge (e.g., edge E1) of the glass ribbon and in contact with an air side surface (ASS) of the glass ribbon. The at least one edge roll (e.g., edge rolls 112a-h) may be configured to impose an outward force or inward force on the edge (e.g., edge E1) of the glass ribbon to control a width of the glass ribbon.

At a step 706, the method 700 may include receiving, with at least one processor (e.g., control system 102), visual data from at least one camera (e.g., camera 106) positioned with a view of the glass ribbon.

At a step 708, the method 700 may include processing, with at least one processor (e.g., control system 102), the visual data to determine a value of at least one dimension (e.g., D1, RW1) associated with the glass ribbon in a region proximate the at least one edge roll (e.g., edge rolls 112a-h).

At a step 710, the method 700 may include determining, with at least one processor (e.g., control system 102), that the value of the at least one dimension associated with the glass ribbon and/or an oscillational frequency of the value in the region proximate the at least one edge roll (e.g., edge rolls 112a-h) fails to satisfy a threshold value.

At a step 712, the method 700 may include generating, with at least one processor (e.g., control system 102), at least one alert associated with the at least one edge roll (e.g., edge rolls 112a-h).

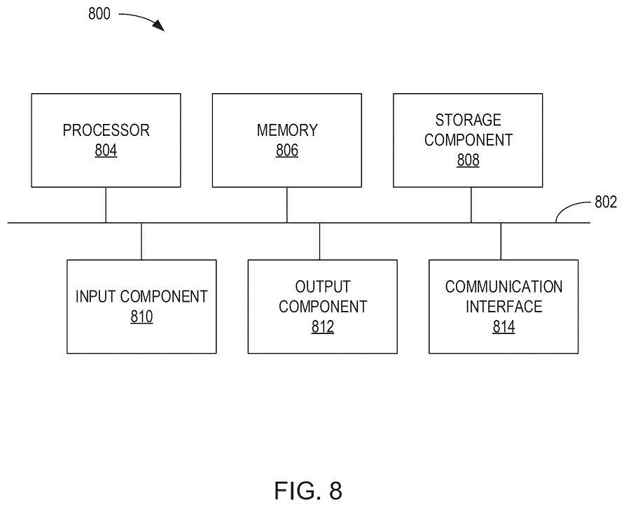

Referring now to FIG. 8, shown is a diagram of example components of a device 800, according to some non-limiting embodiments or aspects. Device 800 may correspond to control system 102, tweel 104, camera 106, communication network 108, computing device 110, edge roll 112, and/or heating element 114, as an example. In some non-limiting embodiments or aspects, such systems or devices may include at least one device 800 and/or at least one component of device 800. The number and arrangement of components shown are provided as an example. In some non-limiting embodiments or aspects, device 800 may include additional components, fewer components, different components, or differently arranged components than those shown. Additionally, or alternatively, a set of components (e.g., one or more components) of device 800 may perform one or more functions described as being performed by another set of components of device 800.

As shown in FIG. 8, device 800 may include bus 802, processor 804, memory 806, storage component 808, input component 810, output component 812, and communication interface 814. Bus 802 may include a component that permits communication among the components of device 800. In some non-limiting embodiments or aspects, processor 804 may be implemented in hardware, firmware, or a combination of hardware and software. For example, processor 804 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 806 may include random access memory (RAM), read only memory (ROM), and/or another type of dynamic or static storage device (e.g., flash memory, magnetic memory, optical memory, etc.) that stores information and/or instructions for use by processor 804.

With continued reference to FIG. 8, storage component 808 may store information and/or software related to the operation and use of device 800. For example, storage component 808 may include a hard disk (e.g., a magnetic disk, an optical disk, a magneto-optic disk, a solid state disk, etc.) and/or another type of computer-readable medium. Input component 810 may include a component that permits device 800 to receive information, such as via user input (e.g., a touch screen display, a keyboard, a keypad, a mouse, a button, a switch, a microphone, etc.). Additionally, or alternatively, input component 810 may include a sensor for sensing information (e.g., a global positioning system (GPS) component, an accelerometer, a gyroscope, an actuator, etc.). Output component 812 may include a component that provides output information from device 800 (e.g., a display, a speaker, one or more light-emitting diodes (LEDs), etc.). Communication interface 814 may include a transceiver-like component (e.g., a transceiver, a separate receiver and transmitter, etc.) that enables device 800 to communicate with other devices, such as via a wired connection, a wireless connection, or a combination of wired and wireless connections. Communication interface 814 may permit device 800 to receive information from another device and/or provide information to another device. For example, communication interface 814 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 800 may perform one or more processes described herein. Device 800 may perform these processes based on processor 804 executing software instructions stored by a computer-readable medium, such as memory 806 and/or storage component 808. A computer-readable medium (e.g., a non-transitory computer-readable medium) is defined herein as a non-transitory memory device. A memory device includes memory space located inside of a single physical storage device or memory space spread across multiple physical storage devices. Software instructions may be read into memory 806 and/or storage component 808 from another computer-readable medium or from another device via communication interface 814. When executed, software instructions stored in memory 806 and/or storage component 808 may cause processor 804 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to”, as used herein, may refer to an arrangement of software, device(s), and/or hardware for performing and/or enabling one or more function (e.g., actions, processes, steps of a process, and/or the like). For example, “a processor configured to” may refer to a processor that executes software instructions (e.g., program code) that cause the processor to perform one or more functions.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method for controlling glass production, comprising:
pouring a glass melt onto a glass production bath of molten metal onto which the glass melt floats to form a glass ribbon;
stretching the glass ribbon on the glass production bath with at least one edge roll proximate to an edge of the glass ribbon and in contact with an air side surface of the glass ribbon, the at least one edge roll configured to impose an outward force or inward force on the edge of the glass ribbon to control a width of the glass ribbon;
receiving, with at least one processor, visual data from at least one camera positioned with a view of the glass ribbon;
processing, with at least one processor, the visual data to determine a value of at least one dimension associated with the glass ribbon in a region proximate the at least one edge roll;
determining, with at least one processor, that the value of the at least one dimension associated with the glass ribbon and/or an oscillational frequency of the value in the region proximate the at least one edge roll fails to satisfy a threshold value; and
generating, with at least one processor, at least one alert associated with the at least one edge roll.

2. The method of claim 1, wherein the at least one dimension associated with the glass ribbon comprises a first width of the glass ribbon in the region proximate the at least one edge roll and/or a distance between the edge of the glass ribbon and the at least one edge roll.

3. The method of claim 1, wherein the stretching step comprises a plurality of edge rolls, and the at least one edge roll comprises a subset of the plurality of edge rolls.

4. The method of claim 1, further comprising:
in response to the at least one alert, maintenancing the at least one edge roll.

5. The method of claim 1, further comprising:
in response to the at least one alert, transmitting a control signal to the at least one edge roll configured to cause the at least one edge roll to execute a response action.

6. The method of claim 5, wherein the response action comprises an adjustment of at least one of: a rotation speed of the at least one edge roll, a location of the at least one edge roll in the glass ribbon, an angle of the at least one edge roll in the glass ribbon, a depth of the edge roll into the glass ribbon, and/or any combination thereof.

7. The method of claim 1, further comprising:
in response to the at least one alert, transmitting a control signal to a heating element located in the glass production bath to cause the heating element to execute a response action.

8. The method of claim 1, wherein determining the value of at least one dimension associated with the glass ribbon in the region proximate the at least one edge roll comprises determining a first width of the molten glass in the region proximate the at least one edge roll and/or a distance between the edge of the glass ribbon and the at least one edge roll by:
identifying, with at least one processor, a location of the at least one edge roll in the visual data;
starting from the location of the at least one edge roll in the visual data, searching, with at least one processor, for a location of a first edge of the glass ribbon in the visual data by searching around the location of the at least one edge roll in the visual data;
identifying, with at least one processor, the location of the first edge of the glass ribbon in the visual data by the searching; and
based on the location of the first edge of the glass ribbon in the visual data, determining, with at least one processor, the width of the glass ribbon in the region proximate the at least one edge roll and/or the distance between the edge of the glass ribbon and the at least one edge roll.

9. The method of claim 1, wherein determining the value of at least one dimension associated with the glass ribbon in the region proximate the at least one edge roll comprises determining a first width of the glass ribbon in the region proximate the at least one edge roll and/or a distance between the edge of the glass ribbon and the at least one edge roll by:
receiving, with at least one processor, an input of at least one user-defined search area and/or user-defined characteristic object in the visual data;
starting from the location of the at least one user-defined search area and/or user-defined characteristic object in the visual data, searching, with at least one processor, for a location of a first edge of the glass ribbon in the visual data by searching around the at least one user-defined search area and/or user-defined characteristic object in the visual data;
identifying, with at least one processor, the location of the first edge of the glass ribbon in the visual data by the searching; and
based on the location of the first edge of the glass ribbon in the visual data, determining, with at least one processor, the first width of the glass ribbon in the region proximate the at least one edge roll and/or the distance between the edge of the glass ribbon and the at least one edge roll.

10. The method of claim 1, further comprising:
determining, with at least one processor, that an image quality of the visual data fails to satisfy a threshold; and
in response to determining that the image quality of the visual data fails to satisfy the threshold: (1) generating, with at least one processor, a notification associated with the at least one camera; and/or (2) cease generating control signals based on the visual data until the image quality of the visual data satisfies the threshold.

11. The method of claim 1, further comprising:
determining, with at least one processor, image quality of the visual data; and
based on the determined image quality, automatically adjusting, with at least one processor, an image processing parameter and/or a camera setting associated with the at least one camera.

12. The method of claim 1, further comprising:
in response to the at least one alert, transmitting, with at least one processor, a control signal to the at least one edge roll and/or a heating element located in the glass production bath;
measuring a response to the control signal by measuring a position of the edge of the glass ribbon and/or a distance between the edge of the glass ribbon and the at least one edge roll;
comparing, with at least one processor, the measured position of the edge of the glass ribbon and/or the distance between the edge of the glass ribbon and the at least one edge roll to historical data associated with the position of the edge of the glass ribbon and/or the distance between the edge of the glass ribbon and the at least one edge roll;
generating, with at least one processor, a further control signal for the at least one edge roll and/or the heating element based on the comparison.

13. A system for controlling glass production, comprising:
a glass production bath comprising a bath of molten metal onto which a glass ribbon floats, the glass production bath comprising at least one edge roll proximate an edge of the glass ribbon, the at least one edge roll configured to impose an outward force or an inward force on the edge of the glass ribbon to control a width of the glass ribbon; and
at least one processor configured to:
receive visual data from at least one camera positioned with a view of the glass ribbon;
process the visual data to determine a value of at least one dimension associated with the glass ribbon in the region proximate the at least one edge roll;
determine that the value of the at least one dimension associated with the glass ribbon and/or an oscillational frequency of the value in the region proximate the at least one edge roll fails to satisfy a threshold value; and
generate at least one alert associated with the at least one edge roll.

14. The system of claim 13, wherein the at least one dimension associated with the glass ribbon comprises a first width of the glass ribbon in the region proximate the at least one edge roll and/or a distance between the edge of the glass ribbon and the at least one edge roll.

15. The system of claim 13, wherein the glass production bath further comprises a plurality of edge rolls, and the at least one edge roll comprises a subset of the plurality of edge rolls.

16. The system of claim 13, wherein in response to the at least one alert, the at least one edge roll is maintenanced.

17. The system of claim 13, the at least one processor configured to:
in response to the at least one alert, transmit a control signal to the at least one edge roll configured to cause the at least one edge roll to execute a response action.

18. The system of claim 17, wherein the response action comprises an adjustment of at least one of: a rotation speed of the at least one edge roll, a location of the at least one edge roll in the glass ribbon, an angle of the at least one edge roll in the glass ribbon, a depth of the at least one edge roll in an air side surface of the glass ribbon, and/or any combination thereof.

19. The system of claim 13, the at least one processor configured to:
in response to the at least one alert, transmit a control signal to a heating element located in the glass production bath to cause the heating element to execute a response action.

20. A computer program product for controlling glass production, the computer program product comprising at least one non-transitory computer-readable medium including one or more instructions that, when executed by at least one processor, cause the at least one processor to:
receive visual data from at least one camera positioned with a view of a glass ribbon floating in a glass production bath, the glass production bath comprising a molten metal onto which the glass ribbon floats, the glass production bath comprising at least one edge roll positioned proximate an edge of the glass ribbon, the at least one edge roll configured to impose an outward force or an inward force on the edge of the glass ribbon to control a width of the glass ribbon;
process the visual data to determine a value of at least one dimension associated with the glass ribbon in a region proximate the at least one edge roll;
determine that the value of the at least one dimension associated with the glass ribbon and/or an oscillational frequency of the value in the region proximate the at least one edge roll fails to satisfy a threshold value; and
generate at least one alert associated with the at least one edge roll.
